(19) United States
(12) Patent Application Publication
(10) Pub. No.: US 2009/0040544 A1
(43) Pub. Date: Feb. 12, 2009

(54) DATA PROCESSING APPARATUS CAPABLE OF PROCESSING DATA OF LATEST VERSION, DATA PROCESSING METHOD AND DATA PROCESSING PROGRAM EMBODIED ON COMPUTER READABLE MEDIUM

(75) Inventors: Kenji MATSUHARA, Kawanishi-shi (JP); Hiroaki Kubo, Muko-shi (JP); Nobuhiro Mishima, Osaka-shi (JP); Kazuo Inui, Itami-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/176,915

(22) Filed: Jul. 21, 2008

(30) Foreign Application Priority Data
Aug. 6, 2007 (JP) 2007-203808

(51) Int. Cl. G06F 3/12

(52) U.S. Cl. 358/1.13; 358/1.15

(57) ABSTRACT

In order to give notice to process the latest data, MFP includes HDD to store data, a data obtaining portion to accept target data to be output, a related data extraction portion to extract related data that is related to the target data and is newer than the target data from the data stored in HDD, a difference extraction portion to extract a difference between the extracted related data and the target data, and an output portion to output the difference.

This application is based on Japanese Patent Application No. 2007-203808 filed with Japan Patent Office on Aug. 6, 2007, the entire content of which is hereby incorporated by reference.

### BACKGROUND OF THE INVENTION

1. Field of the Invention

The present invention relates to a data processing apparatus, a data processing method and a data processing program embodied on a computer readable medium, and more particularly to a data processing apparatus capable of processing data of the latest version, a data processing method executed in the data processing apparatus and a data processing program embodied on a computer readable medium.

2. Description of the Related Art

Recently, a multifunction apparatus called MFP (Multi Function Peripheral), including the functions of a scanner, a printer, a copier and a facsimile machine has emerged. This MFP includes a hard disk drive (HDD) as a mass storage device to allow much data to be stored. On the other hand, Japanese Laid-Open Patent Publication No. 2006-164150 discloses a technique in which when input data is printed, if the same data as that data is stored, the stored data is printed.

However, the data stored in HDD may be changed. Even if data input by the user to allow MFP to output is the old version before update, the same data as the data input by the user is output, and thus the user is unaware of the existence of data of the latest version.

### SUMMARY OF THE INVENTION

The present invention is made to solve the aforementioned problem. An object of the present invention is to provide a data processing apparatus capable of giving notice to process the latest data.

Another object of the present invention is to provide a data processing method allowing notice to be given to process the latest data.

A further object of the present invention is to provide a data processing program allowing notice to be given to process the latest data.

In order to achieve the aforementioned object, in accordance with an aspect of the present invention, a data processing apparatus includes: a storage portion to store data; a data acceptance portion to accept target data to be output; a related data extraction portion to extract related data that is related to the target data and is newer than the target data from data stored in the storage portion; a difference extraction portion to extract a difference between the extracted related data and the target data; and a difference output portion to output the difference.

In accordance with another aspect of the present invention, a data processing method performed in a data processing apparatus including a storage portion to store data includes the steps of: accepting target data to be output; extracting data that is related to the target data and is newer than the target data from data stored in the storage portion; extracting a difference between the extracted related data and the target data; and outputting the difference.

In accordance with a further aspect of the present invention, a data processing program embodied on a computer readable medium causes a computer including a storage portion to store data to execute processing including the steps of: accepting target data to be output; extracting data that is related to the target data and is newer than the target data from data stored in the storage portion; extracting a difference between the extracted related data and the target data; and outputting the difference.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall diagram schematically showing an information processing system in an embodiment of the present invention.

FIG. 2 is an external perspective view of MFP.

FIG. 3 is a block diagram showing an exemplary circuit configuration of MFP.

FIG. 4 is a plan view showing an exemplary operation panel.

FIG. 5 is a functional block diagram showing an exemplary function of CPU.

FIG. 6 is a flowchart showing an exemplary flow of a data output process.

FIG. 7 is a flowchart showing an exemplary flow of a related data extraction process.

FIG. 8 is a flowchart showing an exemplary flow of an output process.

FIG. 9 is a view showing an example of a combination data display window.

FIG. 10 is a flowchart showing an exemplary flow of a normal output process.

FIG. 11 is a functional block diagram showing an overall function of CPU included in MFP in a second embodiment.

FIG. 12 is a flowchart showing an exemplary flow of a client process executed by CPU included in PC.

FIG. 13 is a flowchart showing an exemplary flow of a data output process executed by MFP in the second embodiment.

FIG. 14 is a flowchart showing an exemplary flow of a related mail transmission process.

FIG. 15 is a first diagram showing an example of an email.

FIG. 16 is a second diagram showing an example of an email.

FIG. 17 is a third diagram showing an example of an email.

FIG. 18 is a diagram showing an example of combination data.

### DESCRIPTION OF THE PREFERRED EMBODIMENTS

In the following, embodiments of the present invention will be described with reference to the figures. In the following description, the same parts will be denoted with the same reference characters. Their designations and functions are also the same. Therefore, a detailed description thereof will not be repeated.

### First Embodiment

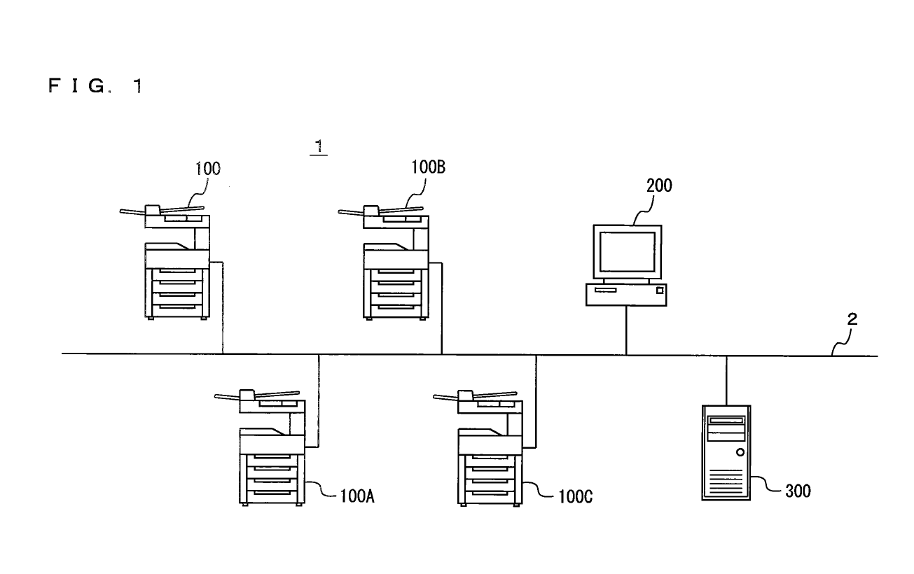

FIG. 1 is an overall diagram schematically showing an information processing system in an embodiment of the present invention. Referring to FIG. 1, an information processing system 1 includes Multi Function Peripherals (referred to as “MFP” hereinafter) 100, 100A, 100B, 100C, a personal computer (referred to as “PC” hereinafter) 200, and a mail server 300, each connected to a network 2. Here, MFPs 100, 100A, 100B, 100C are described as an example of a data processing apparatus. MFPs 100, 100A, 100B, 100C include a plurality of functions such as a scanner function, a printer function, a copy function, and a facsimile function. PC 200 and mail server 300 are general computers.

Network 2 is a local area network (LAN), whether wired or wireless. Network 2 is not limited to a LAN, or may be a wide area network (WAN), a public switched telephone network (PSTN), or the like.

MFPs 100, 100A, 100B, 100C include an email transmission/reception function. MFPs 100, 100A, 100B, 100C each have an email transmission/reception program installed therein to transmit emails to mail server 300 or to receive emails from mail server 300.

It is noted that although MFPs 100, 100A, 100B, 100C are described as an example of the data processing apparatus in the present embodiment, MFPs 100, 100A, 100B, 100C may be replaced by, for example, personal computers, scanners, printers, facsimiles, or the like.

The function of each of MFP 100, 100A, 100B, 100C is the same. Here, taking MFP 100 as an example, the configuration will be described.

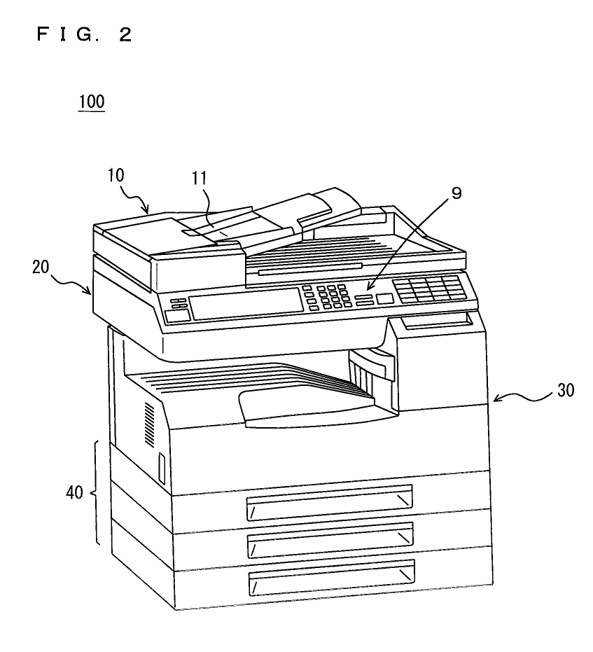

FIG. 2 is an external perspective view of MFP. Referring to FIG. 2, MFP 100 includes an automatic document feeder (ADF) 10, an image reading portion 20, an image formation portion 30, and a paper-feeding portion 40.

ADF 10 automatically conveys an original document having a number of pages set on a document feeding tray 11, one by one, to a prescribed document reading position set on a platen glass of image reading portion 20 and discharges the original document having an original document image read by image reading portion 20 onto a document discharge tray. Image reading portion 20 includes a light source applying light to an original document conveyed to the document reading position and a photoelectric conversion device receiving light reflected on the original document and scans the original document image corresponding to the size of the original document. The photoelectric conversion device converts the received light into image data as an electrical signal for output to image formation portion 30. Paper-feeding portion 40 conveys a sheet of paper (recording medium) stored in the paper-feeding tray to image formation portion 30.

Image formation portion 30 forms an image by a well-known electrophotography technique and performs a variety of data processing such as shading correction on the image data input from image reading portion 20 to form an image on the paper conveyed by paper-feeding portion 40 based on the image data after the data processing.

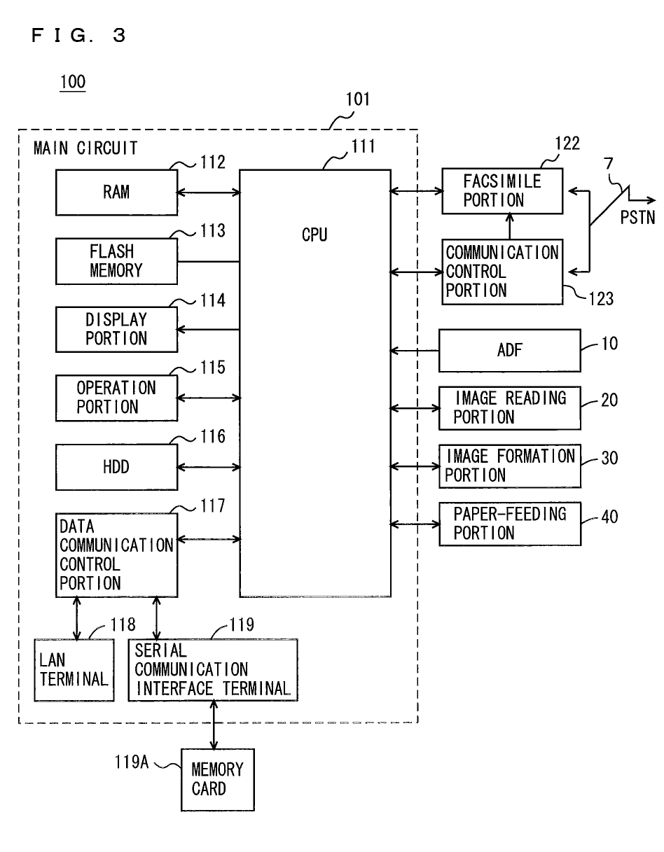

FIG. 3 is a block diagram showing an exemplary circuit configuration of MFP. With reference to FIG. 3, MFP 100 includes a main circuit 101, a facsimile portion 122, and a communication control portion 123. Main circuit 101 is connected to automatic document feeder (ADF) 10, image reading portion 20, image formation portion 30, and paper-feeding portion 40.

Main circuit 101 includes a CPU 111, a RAM (Random Access Memory) 112 used as a work area for CPU 111, a flash memory 113 for storing a program executed by CPU 111 and the like, a display portion 114, an operation portion 115, a hard disk drive (HDD) 116 as a mass storage device, and a data communication control portion 117.

CPU 111 executes a program stored in flash memory 113 to perform a function. Flash memory 113 is an EEPROM (Electronically Erasable Programmable Read Only Memory).

CPU 111 is connected to each of display portion 114, operation portion 115, HDD 116 and data communication control portion 117 to control the entire main circuit 101. CPU 111 is also connected to facsimile portion 122, communication control portion 123, ADF 10, image reading portion 20, image formation portion 30, and paper-feeding portion 40 to control the entire MFP 100.

Display portion 114 is a display such as a liquid crystal display (LCD) or an organic ELD (Electro Luminescence Display) to display instruction menus for the user, information about the obtained image data, and the like. Operation portion 115 includes a plurality of keys and accepts inputs of a variety of instructions and data such as characters and numerals by the user's operations corresponding to keys. Operation portion 115 includes a touch-panel provided on display portion 114. Display portion 114 and operation portion 115 constitute operation panel 9 provided on the top face of MFP 100.

Data communication control portion 117 has a LAN terminal 118 which is an interface for communications via a communication protocol such as TCP (Transmission Control Protocol) or UDP (User Datagram Protocol), and a serial communication interface terminal 119 for serial communications. Data communication control portion 117 transmits/receives data to/from external equipment connected to LAN terminal 118 or serial communication interface terminal 119, according to an instruction from CPU 111.

When a LAN cable for connecting to network 2 is connected to LAN terminal 118, data communication control portion 117 communicates with other MFPs 100A, 100B, 100C, PC 200 or mail server 300 connected through LAN terminal 118. In addition, data communication control portion 117 communicates with other computers connected to the Internet.

CPU 111 may control data communication control portion 117 to download a program from PC 200 for storage into flash memory 113 thereby updating a program. The program includes a data output program as described later.

When equipment is connected to serial communication interface terminal 119, data communication control portion 117 communicates with the equipment connected to serial communication interface terminal 119, for example, a digital camera, a digital video camera or a mobile information terminal to input/output image data. A memory card 119A containing a flash memory may also be connected to serial communication interface terminal 119. CPU 111 may control data communication control portion 117 to read a program executed by CPU 111 from memory card 119A for storage into flash memory 113 thereby updating a program.

It is noted that a recording medium storing a program executed by CPU 111 is not limited to memory card 119A and may be a medium such as a flexible disk, a cassette tape, an optical disk (CD-ROM (Compact Disc-Read Only Memory)/MO (Magnetic Optical Disc/MD (Mini Disc)/DVD (Digital Versatile Disc)), an IC card (including a memory card), an optical card, or a semiconductor memory such as a mask ROM, EPROM (Erasable Programmable ROM), or EEPROM. Alternatively, CPU 111 may download a program from PC 200 for storage into flash memory 113, or PC 200 may write a program into flash memory 113 so that the program stored in flash memory 113 is loaded into RAM 112 and executed by CPU 111. The program referred to herein includes not only a program directly executable by CPU 111 but also a source program, a compressed program, an encrypted program, and the like.

Communication control portion 123 is a modem for connecting CPU 111 to Public Switched Telephone Network (PSTN) 7. A telephone number in PSTN 7 is assigned to MFP 100 beforehand, and when a call is originated from a facsimile machine connected to PSTN 7 to the telephone number assigned to MFP 100, communication control portion 123 detects the call. Upon detection of the call, communication control portion 123 establishes a call to allow facsimile portion 122 to communicate.

Facsimile portion 122 is connected to PSTN 7 to transmit facsimile data to PSTN 7 or receive facsimile data from PSTN 7.

MFP 100 performs two kinds of processes, namely, an original document reading process or a data designation process, as a data input process of inputting data. The original document reading process is a process of allowing image reading portion 20 to read an original document and setting the output original document image as input data. The data designation process is a process of setting data designated by the user with operation portion 115 as input data, of the data stored in a predetermined region (referred to as “BOX” hereinafter) of HDD 116. Designation of data includes designation of the file name of data and designation of URL allocated to data.

In addition, MFP 100 performs four kinds of processes, namely, an image formation process, a data storage process, a facsimile transmission process, and a data transmission process, as a data output process of outputting data. The image formation process is a process of allowing image formation portion 30 to form an image of data on a sheet of paper. The data storage process is a process of storing data in any given BOX of HDD 116. The facsimile transmission process is a process of allowing facsimile portion 122 to transmit data by a procedure defined by a facsimile standard. The data transmission process is a process of allowing data communication control portion 117 to transmit data or URL allocated to data to another computer through network 2. The transmission method is, for example, emails, FTP, SMB (Server Message Block), or the like.

A process performed by MFP 100 is determined by a combination of two kinds of data input processes and four kinds of data output processes. A scan process is a combination of the original document reading process as a data input process and the data storage process as a data output process. Specifically, the scan process is a process of storing data obtained by image reading portion 20 reading an original document, into any given BOX.

A copy process is a combination of the original document reading process as a data input process and the image formation process as a data output process. Specifically, the copy process is a process of image formation portion 30 forming an image of data obtained by image reading portion 20 reading an original document, on a sheet of paper.

A facsimile process is a combination of the original document reading process or the data designation process as a data input process and the facsimile transmission process as a data output process. Specifically, the facsimile process is a process of facsimile portion 122 transmitting data obtained by image reading portion 20 reading an original document or data designated from data stored in BOX.

A data transmission process is a combination of the original document reading process or the data designation process as a data input process and the data transmission process as a data output process. Specifically, the data transmission process is a process of transmitting data obtained by image reading portion 20 reading an original document or data designated from data stored in BOX, to another computer by a designated transmission method. If URL is input, the designated data includes data specified by that URL.

A BOX print process is a combination of the data designation process as a data input process and the image formation process as a data output process. Specifically, the BOX print process is a process of image formation portion 30 forming an image of data designated from data stored in BOX, on a sheet of paper.

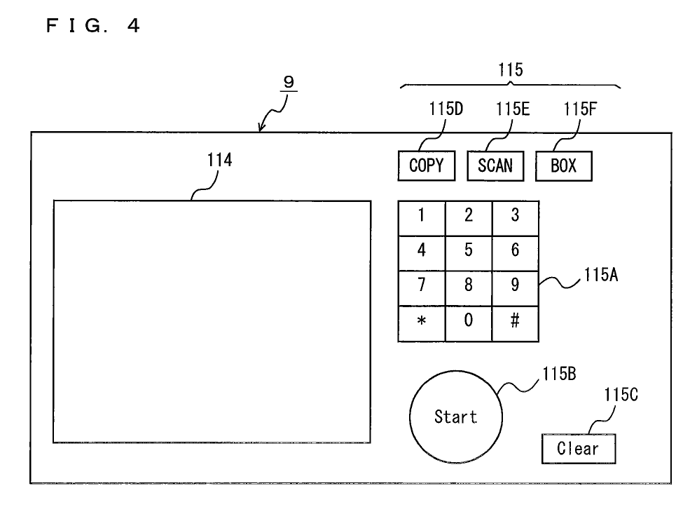

FIG. 4 is a plan view showing an exemplary operation panel. Referring to FIG. 4, operation panel 9 includes display portion 114 and operation portion 115. Operation portion 115 includes a ten-key pad 115A, a start key 115B, a clear key 115C for cancelling the input content, a copy key 115D for allowing MFP 100 to make a transition to a copy mode for performing a copy process, a scan key 115E for allowing MFP 100 to make a transition to a scan mode for performing a scan process, and a BOX key 115F for allowing MFP 100 to make a transition to a data designation mode for performing a data designation process.

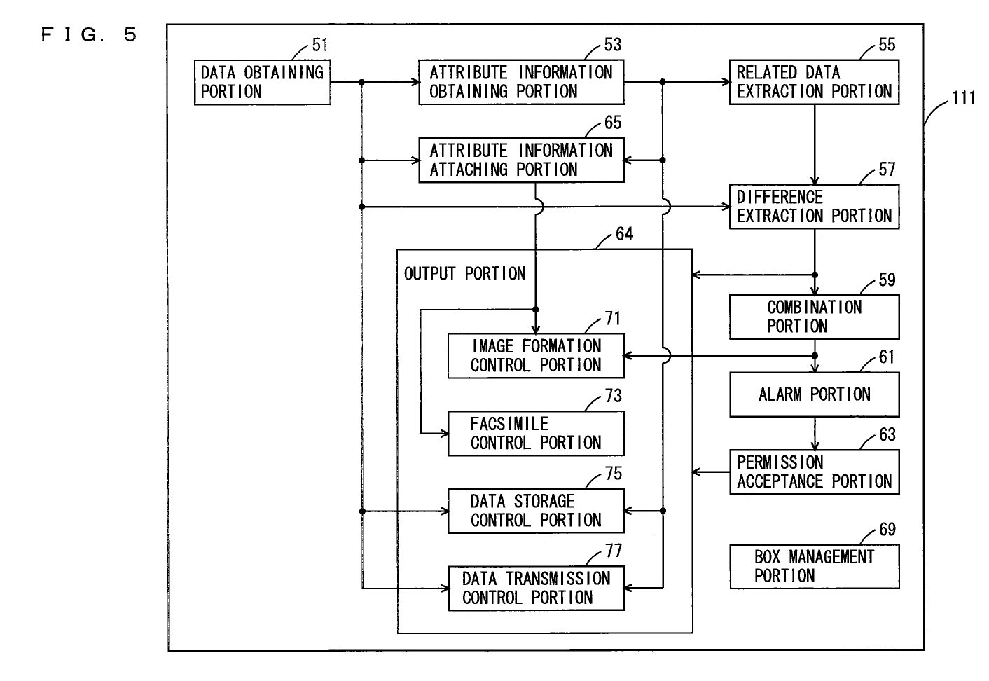

FIG. 5 is a functional block diagram showing an exemplary function of CPU. Referring to FIG. 5, CPU 111 includes a data obtaining portion 51 for obtaining data, an attribute information obtaining portion 53 for obtaining attribute information from the obtained data, a related data extraction portion for extracting related data related to the obtained data from data stored in HDD 116, a difference extraction portion 57 for extracting a difference between the obtained data and the related data, a combination portion 59 for combining the obtained data with the difference, an alarm portion 61, a permission acceptance portion 63 for accepting a permission to output data, a BOX management portion 69 for managing data stored in BOX, an attribute information attaching portion 65 for attaching attribute information to the obtained data, and an output portion 64 for outputting data.

Data obtaining portion 51 obtains data and outputs the obtained data to attribute information obtaining portion 53, difference extraction portion 57, attribute information attaching portion 65 and output portion 64. When a user inputs the respective instructions for the scan process, the copy process, the facsimile process and the data transmission process to operation portion 115, data obtaining portion 51 obtains data.

Specifically, when operation portion 115 receives an instruction for the original document reading process as a data input process, data obtaining portion 51 obtains an original document image output by image reading portion 20 reading an original document. Data obtaining portion 51 obtains the original document image obtained from image reading portion 20 as data. Furthermore, when operation portion 115 receives an instruction for the data designation process as a data input process, data obtaining portion 51 reads data specified by a file name or URL included in the instruction for the data designation process, from HDD 116. Data obtaining portion 51 obtains data read from HDD 116.

Attribute information obtaining portion 53 obtains attribute information of data obtained by data obtaining portion 51. When operation portion 115 receives an instruction for the data designation process as a data input process, attribute information obtaining portion 53 obtains attribute information of data specified by a file name or URL included in the instruction for the data designation process. The attribute information includes identification information of data and a date and time (recording date and time) at which data was stored in HDD 116. The identification information is a file name, here, and the recording date and time includes year/month/date and time. Specifically, the profile of data specified by the file name or URL included in the instruction for the data designation process is read, and the year/month/date and time of storage into HDD 116 that is included in the profile is obtained. Attribute information obtaining portion 53 outputs attribute information including the file name as identification information and the year/month/date and time of storage into HDD 116 as the recording date and time, to related data extraction portion 55, attribute information attaching portion 65 and output portion 64.

Furthermore, when operation portion 115 receives an instruction for the original document reading process as a data input process, attribute information obtaining portion 53 extracts attribute information from the data obtained by data obtaining portion 51. The original document image read by image reading portion 20 may include attribute information attached thereto. Therefore, attribute information obtaining portion 53 extracts attribute information from the data obtained by data obtaining portion 51. If the attribute information is attached as an image of characters, the image of characters is extracted from the image of data for character recognition. If the attribute information is attached as an image represented by a code such as a barcode, the image represented by a code is extracted and analyzed. If the attribute information is attached as being embedded as a pattern, the image of a pattern is extracted from the image of data and the image of a pattern is analyzed. If the attribute information is embedded by watermarking, the attribute information embedded in the image of data is extracted using a watermarking technique. Attribute information obtaining portion 53 outputs the extracted attribute information to related data extraction portion 55, attribute information attaching portion 65 and output portion 64.

When operation portion 115 receives an instruction for the image formation process as a data output process, attribute information attaching portion 65 reads data specified by the file name or URL included in the instruction for the data designation process and adds the attribute information input from attribute information obtaining portion 53 to the read data. The attribute information may be attached to data by combining an image representing attribute information by characters or an image represented by a code such as a barcode with an image of data, by embedding attribute information in a pattern and combining the image of the pattern with the image of data, or by embedding attribute information in data using a watermarking technique.

Attribute information attaching portion 65 outputs the data having attached attribute information to an image formation control portion 71 included in output portion 64. Image formation control portion 71 outputs data to image formation portion 30 and allows image formation portion 30 to form an image of data on paper. Thus, the image of data having the attached information is formed on paper.

Related data extraction portion 55 extracts related data related to the data obtained by data obtaining portion 51 from data stored in HDD 116, based on the attribute information input from attribute information obtaining portion 53. Specifically, extracted as related data is data with a file name identical or similar to the file name included in the attribute information as identification information and with the most recent year/month/date and time that it was stored in HDD 116. It is noted that the date and time at which the related data was stored in HDD 116 is extracted on condition that it is later than the year/month/date and time included in attribute information as a recording date and time. This is because the data obtained by data obtaining portion 51 is the latest data. Related data extraction portion 55 outputs the extracted related data to difference extraction portion 57.

Difference extraction portion 57 extracts the difference between the data obtained by data obtaining portion 51 and the related data. Specifically, if the data obtained by data obtaining portion 51 is document data, the document data is converted into text as first text data, and if the data obtained by data obtaining portion 51 is an image, character recognition is performed for conversion into text data as first text data. If the related data is document data, the document data is converted into text as second text data, and if the related data is an image, character recognition is performed for conversion into text data as second text data. Then, the difference between the first text data and the second text data is extracted. The difference includes a deleted part which exists in the first text data and does not exist in the second text data and an added part which does not exist in the first text data but exists in the second text data. It is noted that if the deleted part and the added part exist in the same location, a part formed by merging the deleted part and the added part together may be set as a changed part.

If the proportion of the difference in either the first text data or the second text data (referred to as “difference proportion” hereinafter) is equal to or greater than a prescribed threshold value T, difference extraction portion 57 determines that the data obtained by data obtaining portion 51 has been updated from the related data and then outputs an instruction to output the data obtained by data obtaining portion 51 to output portion 64. If the difference proportion is smaller than threshold value T, difference extraction portion 57 outputs a combination instruction, the data obtained by data obtaining portion 51 and the difference to combination portion 59 and also outputs a wait signal to output portion 64.

When a combination instruction is input from difference extraction portion 57, combination portion 59 combines the image of the data obtained by data obtaining portion 51 with the image of the difference to generate combination data. Then, the combination data is output to image formation control portion 71 and alarm portion 61. Combination portion 59 converts the image of the difference into an image having a color different from that of the image of the data obtained by data obtaining portion 51 and combines the converted image. Here, an image representing characters “added,” “changed” or “deleted” may be combined in the vicinity of the location where the difference is combined. In this case, the color of characters to be combined is preferably different from the color of the other image. This is to indicate that the characters do not exist in either the image of the data obtained by data obtaining portion 51 and the image of the difference.

Alarm portion 61 displays the combination data on display portion 114. Thus, the user of MFP 100 knows that the data to be processed is the data of the older version. In addition, since the combination data includes the image of the difference in a different color from the other image, the user of MFP 100 knows which portion of the data to be processed has been changed, added or deleted.

When the combination data is displayed by alarm portion 61, permission acceptance portion 63 displays a message on display portion 114 to inquire whether to continue the process or not and accepts an instruction to a permission button preset on operation portion 115. Upon an instruction to the permission button, permission acceptance portion 63 outputs an output instruction to output portion 64.

Output portion 64 receives data from data obtaining portion 51 and receives data having attribute information attached thereto from attribute information attaching portion 65. When an output signal is input from difference extraction portion 57, output portion 64 outputs either the data input from data obtaining portion 51 or the data having attribute information attached as input from attribute information attaching portion 65. In addition, when a wait signal is input from difference extraction portion 57, output portion 64 waits until a permission signal is input from permission acceptance portion 63, and on condition that a permission signal is input, output portion 64 outputs either the data input from data obtaining portion 51 or the data having attribute information attached as input from attribute information attaching portion 65. Which of the data input from data obtaining portion 51 or the data having attribute information attached as input from attribute information attaching portion 65 is input depends on the input instruction for the data output process.

Output portion 64 includes image formation control portion 71, a facsimile control portion 73, a data storage control portion 75, and a data transmission control portion 77. The respective operations of image formation control portion 71, facsimile control portion 73, data storage control portion 75 and data transmission control portion 77 will be described below.

When the image formation process is designated as a data output process, image formation control portion 71 receives data having attribute information attached from attribute information attaching portion 65. Image formation control portion 71 also receives combination data from combination portion 59 and outputs one of the data having attribute information attached and the combination data according to the user's selection. Image formation control portion 71 outputs either the data having attribute information attached or the combination data to image formation portion 30 to allow it to form either an image of the data having attribute information attached or an image of the combination data on paper. Here, description will be made by way of example to the case where the data provided with attribute information is selected by the user. When an output signal is input from difference extraction portion 57, image formation control portion 71 outputs the data provided with attribute information. When a wait signal is input from difference extraction portion 57, image formation control portion 71 waits until a permission signal is input from permission acceptance portion 63, and on condition that a permission signal is input, image formation control portion 71 outputs the data provided with attribute information.

Furthermore, image formation control portion 71 switches the mode of image formation portion 30 to one of a color mode of forming an image in color and a monochrome mode of forming an image only in black. When combination data is selected by the user, image formation control portion 71 switches the mode of image formation portion 30 to the color mode. However, if the user selects the combination data when the mode of image formation portion 30 is switched to the monochrome mode, image formation control portion 71 displays a warning message on display portion 114. The warning message includes, for example, “Printing will be done in color. OK?” Then, the process stands by until the user inputs an instruction to permit formation of the image to operation portion 115, and when an instruction to permit is input to operation portion 115, the combination data is output to image formation portion 30.

When the facsimile transmission process is designated as a data output process, facsimile control portion 73 receives data having attribute information attached from attribute information attaching portion 65. Facsimile control portion 73 outputs the data having attribute information attached to facsimile portion 122 to allow it to transmit the data having attribute information attached according to the facsimile standard. When an output signal is input from difference extraction portion 57, facsimile control portion 73 outputs the data provided with attribute information to facsimile portion 122. In addition, when a wait signal is input from difference extraction portion 57, facsimile control portion 73 waits until a permission signal is input from permission acceptance portion 63, and on condition that a permission signal is input, facsimile control portion 73 outputs the data provided with attribute information to facsimile portion 122.

Data storage control portion 75 receives attribute information from attribute information obtaining portion 53, and, when the data storage process is designated as a data output process, receives data from data obtaining portion 51. When an output signal is input from difference extraction portion 57, data storage control portion 75 stores the data input from data obtaining portion 51 into a region (BOX) of HDD 116 specified by designation. When storing data in HDD 116, data storage control portion 75 sets the file name and the recording date and time included in the attribute information in the profile and stores the profile together with the data. When a wait signal is input from difference extraction portion 57, data storage control portion 75 waits until a permission signal is input from permission acceptance portion 63, and, on condition that a permission signal is input, data storage control portion 75 stores the data into a region (BOX) of HDD 116 specified by designation.

Data transmission control portion 77 receives attribute information from attribute information obtaining portion 53, and when the data transmission process is designated as a data output process, receives data from data obtaining portion 51. When an output signal is input from difference extraction portion 57, data transmission control portion 77 outputs the data input from data obtaining portion 51 and the attribute information to data communication control portion 117 to allow data communication control portion 117 to transmit the data and the attribute information to a recipient specified by designation. When a wait signal is input from difference extraction portion 57, data transmission control portion 77 waits until a permission signal is input from permission acceptance portion 63, and, on condition that a permission signal is input, data transmission control portion 77 outputs the data and the attribute information to data communication control portion 117 to allow data communication control portion 117 to transmit the data and the attribute information to a recipient specified by designation.

BOX management portion 69 manages BOX held by HDD 116. Specifically, BOX is created or deleted, data is added to BOX, or data stored in BOX is changed or deleted, according to an operation input by the user to operation portion 115. In addition, when MFP 100 is remotely operated by another computer connected to network 2, BOX is created or deleted, data is added to BOX, or data stored in BOX is changed or deleted, according to an instruction received from another computer.

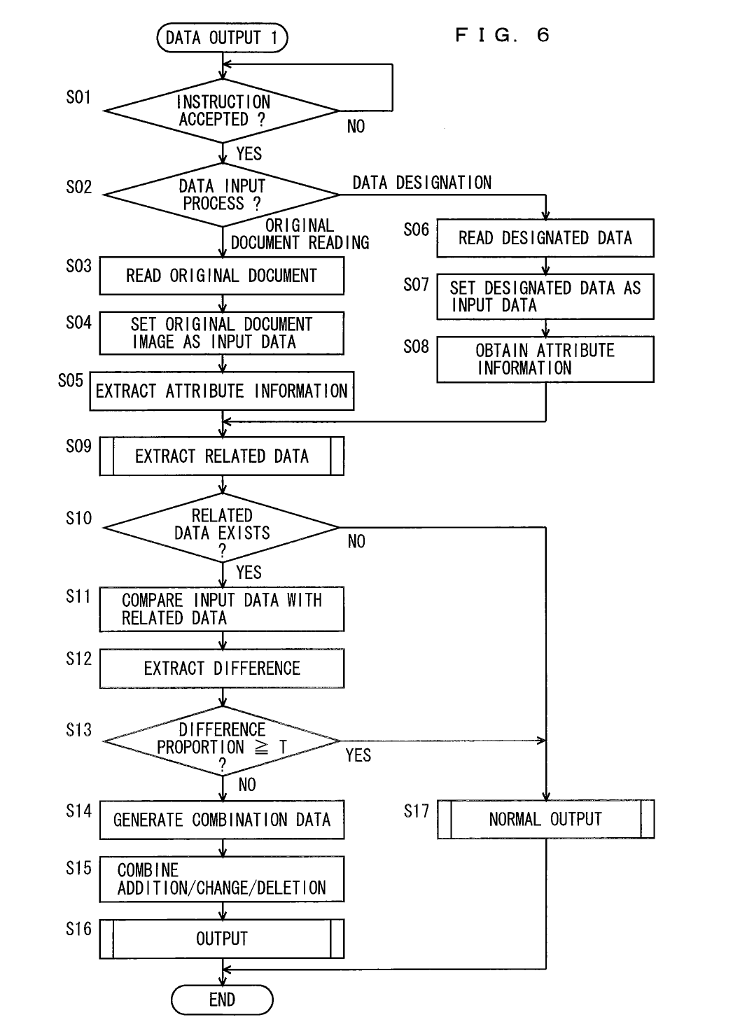

FIG. 6 is a flowchart showing an exemplary flow of the data output process. The data output process is a process executed by CPU 111 by CPU 111 executing the data output program stored in flash memory 113.

Referring to FIG. 6, CPU 111 determines whether or not an instruction to perform a process is accepted (step S01). The process stands by until the instruction is accepted (NO in step S01), and if the instruction is accepted, the process proceeds to step S02. MFP 100 in the present embodiment is capable of performing any of the scan process, the copy process, the facsimile process, the data transmission process and the BOX print process and thus accepts an instruction to perform any one of these processes.

Then, the process branches depending on the data input process of the accepted instruction (step S02). If the data input process is the original document reading process, the process proceeds to step S03, and if the data designation process, the process proceeds to step S06.

In step S03, image reading portion 20 is allowed to read an original document image so that an original document image is obtained as electronic data output by image reading portion 20. The original document image is data in the bitmap format. Then, the obtained original document image is set as input data (step S04), and attribute information is extracted (step S05). Specifically, the attribute information included in the original document image is extracted. If the attribute information is attached to the original document image as an image of characters, the image of characters is extracted from the original document image for character recognition. If the attribute information is attached as an image represented by a code such as a barcode, the image represented by a code is extracted and the code is analyzed. If the attribute information is attached as being embedded in a pattern, an image of a pattern is extracted from the original document image and the image of a pattern is analyzed. If the attribute information is embedded by watermarking, the attribute information embedded in the original document image is extracted using a watermarking technique.

On the other hand, in step S06, data designated by the instruction to perform the data designation process is read from HDD 116. Then, the read data is set as input data (step S07). Furthermore, attribute information is obtained from the profile of the read data (step S08), and the process then proceeds to step S09.

In step S09, a related data extraction process is performed. The related data extraction process, which will be described later, is a process of extracting one data related to the input data, as related data, from data stored in HDD 116.

In step S10, it is determined whether or not related data is extracted. If related data is extracted, the process proceeds to step S11, and if not extracted, the process proceeds to step S17. In step S17, a normal output process is performed, and the data output process then ends. The normal output process will be described later.

In step S11, the input data is compared with the related data. Specifically, if the input data is document data, that document data is converted into text as first text data, and if the input data is in a format representing an image such as bitmap format or JPEG (Joint Photographic Experts Group) format, the image is subjected to character recognition and converted into text data as first text data. As for the related data, similarly, if the related data is document data, that document data is converted into text as second text data, and if the related data is in a format representing an image, the image is subjected to character recognition and converted into text data as second text data. Then, the first text data and the second text data are compared with each other.

In step S12, the difference between the first text data and the second text data is extracted. The difference includes a deleted part which exists in the first text data and does not exist in the second text data and an added part which does not exist in the first text data but exists in the second text data. It is noted that if a deleted part and an added part exist in the same location, a changed part may be formed by merging the deleted part and the added part together. Although here the difference is extracted after conversion into text data, comparison may be made in a format such as bitmap.

In step S13, a difference proportion is obtained from the difference extracted in step S12, and it is determined whether the difference proportion is equal to or greater than predetermined threshold value T. The difference proportion is a proportion of the difference in either the first text data or the second text data. If the difference proportion is equal to or greater than threshold value T, the process proceeds to step S17, and if not, the process proceeds to step S14. If the difference proportion between the input data and the related data is too large (if the difference proportion is equal to or greater than threshold value T), it is determined that the input data and the related data are data of different kinds. Then, the input data is output in a normal process procedure (step S17).

In step S14, combination data is generated. The combination data is an image formed by combining an image of input data with an image of difference. The combination data is formed by converting the color of the image of difference into a color different from the color of the image of input data and combining the image of input data with the image of difference.

Furthermore, in step S15, an image representing characters “added,” “changed” or “deleted” is combined in the vicinity of the location where the image of difference is combined in the image of input data. By referring to the combination data, the fact that data newer than the input data exists and the corrected part can be confirmed. Then, an output process is performed (step S16), and the process then ends. The output process will be described later.

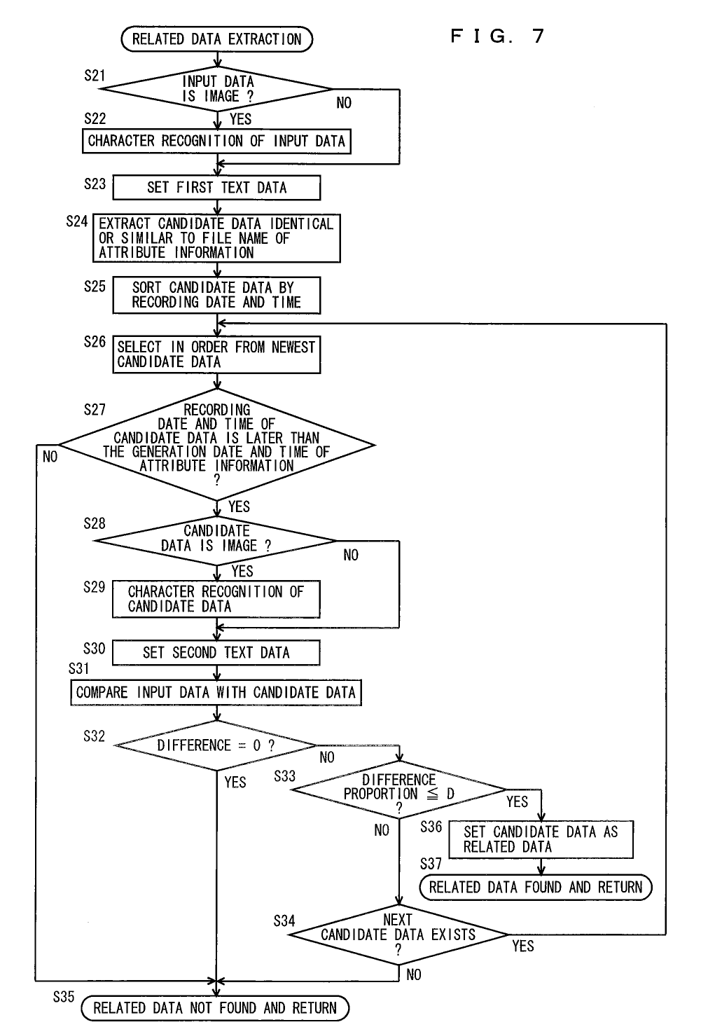

FIG. 7 is a flowchart showing an exemplary flow of the related data extraction process. The related data extraction process is a process performed in step S09 in FIG. 6. Referring to FIG. 7, it is determined whether or not the input data is an image (step S21). It is determined whether or not the format of the input data is a format defined to represent an image. If the format is a format defined to represent an image, the process proceeds to step S22, and if not, the process proceeds to step S23. Specifically, if the data input process is the original document reading process, it is determined that the format of the input data represents image. If the data input process is the data designation process, it is determined whether or not the format of the input data represents image, based on the extension of the file of the input data. In step S22, the input data is subjected to character recognition and converted into text data. In the next step S23, if the process proceeds from step S22, the text data converted from the input data is set as first text data, and if the process proceeds from step S21, the application program corresponding to the input data is started, the characters included in the input data are extracted, and text data formed of the extracted characters is set as first text data.

Then, in step S24, data having the file name identical or similar to the file name of attribute information of the input data is extracted as candidate data from the data stored in HDD 116. If a plurality of data each having a file name identical or similar to the file name of attribute information of the input data are stored, all of them are extracted as candidate data.

In step S25, if a plurality of data are extracted, the plurality of candidate data are sorted by the date and time at which they were stored in HDD 116. Then, one of candidate data is selected as a process target in the chronological order of the date and time of storage, most recent first (step S26). In step S27, it is determined whether or not the date and time at which the candidate data selected as the process target was stored in HDD 116 is later than the recording date and time included in attribute information of the input data. If the date and time at which the candidate data selected as the process target was stored in HDD 116 is later than the recording date and time included in attribute information of the input data, the process proceeds to step S28, and if not, the process proceeds to step S35. This is to determine data of a version newer than the input data as related data.

In step S28, it is determined whether or not the candidate data selected as the process target is an image. Specifically, it is determined whether or not the format of the candidate data is a format defined to represent an image, for example, by the extension of the file name of the candidate data. If the candidate data is an image, the process proceeds to step S29, and if not, the process proceeds to step S30.

In step S29, the candidate data is subjected to character recognition and converted into text data. In the next step S30, if the process proceeds from step S29, the text data converted from the candidate data is set as second text data, and if the process proceeds from step S28, the application program corresponding to the candidate data is started, the characters included in the candidate data are extracted, and the text data formed of the extracted characters is set as second text data.

In step S31, the input data is compared with the candidate data. Specifically, the first text data set in step S23 is compared with the second text data set in step S30. Then, in step S32, it is determined whether or not the difference is 0, as a result of the comparison. The difference includes a part (deleted part) which does not exist in the candidate data but exists in the input data and a part (added part) which does not exist in the input data but exists in the candidate data. If the difference is 0, the process proceeds to step S35, and if the difference is not 0, the process proceeds to step S33. In step S35, “related data not found” is set in the return value, and the process returns to the data output process. Since data identical to the input data is stored in HDD 116, in that case, the input data is treated as data of the latest version.

In step S33, as a result of the comparison in step S31, it is determined whether or not the difference proportion is equal to or smaller than a threshold value D. If the difference is equal to or smaller than threshold value D, the process proceeds to step S36, and if not, the process proceeds to step S34. The difference proportion is a proportion of the difference in the input data or the candidate data. Here, the difference proportion is a proportion of the characters included in the difference to the characters of the first text data or the second text data. If the difference is greater than threshold value D, the process proceeds to step S34, since in that case, the candidate data is to be treated as another data different from the input data.

In step S34, it is determined whether or not there exists candidate data to be processed next. If there exists candidate data to be processed, the process returns to step S26, and if not exist, the process proceeds to step S35.

Meanwhile, in step S36, the candidate data is set as related data, and the process proceeds to step S37. In step S37, “related data found” is set in the return value, and the process returns to the output process.

In this manner, in the related data extraction process, extracted from the data stored in HDD 116 as related data is data with a file name identical or similar to that of the input data and with the latest time and date of storage into HDD 116, which is later than the recording date and time included in the attribute information of the input data. Here, data identical to the input data and data having the difference proportion over threshold value D are excluded from the related data. It is noted that although here the input data and the candidate data are compared with each other after being respectively converted into text data, the input data and the candidate data may be converted into images and then compared. In any case, the input data and the candidate data need to be converted into the same data kind for comparison.

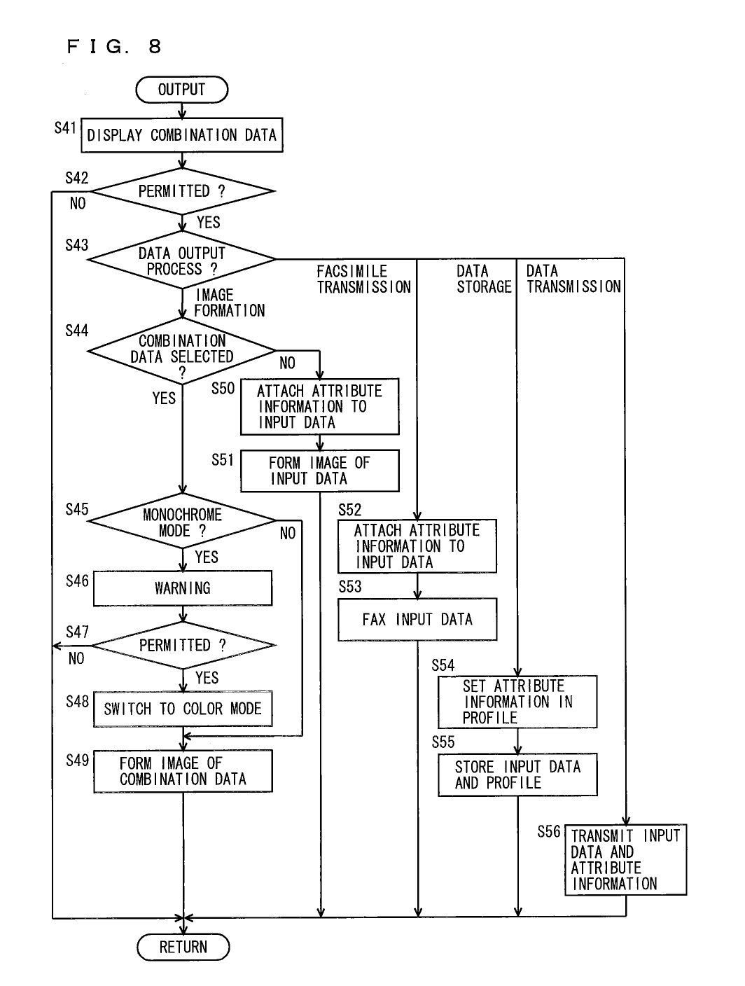

FIG. 8 is a flowchart showing an exemplary flow of the output process. The output process is a process performed in step S16 of the data output process shown in FIG. 6. Referring to FIG. 8, CPU 111 displays combination data on display portion 114. The combination data is an image generated in step S14 in FIG. 6. Here, a combination data display window for displaying an image of combination data appears on display portion 114.

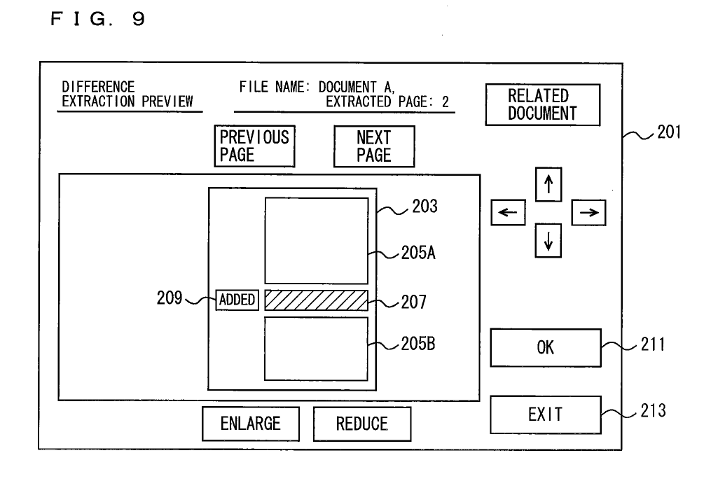

FIG. 9 is a view showing an exemplary combination data display window. Referring to FIG. 9, combination data display window 201 includes a region 203 in which an image of combination data is displayed, a button 211 showing characters “OK,” and a button 213 showing characters “exit.” Button 211 is a button for a user to input an instruction to permit outputting the input data. Button 213 is a button for a user to input an instruction not to permit outputting the input data. Region 203 in which combination data is displayed includes the same parts 205A, 205B and a different part 207 between the input data and the related data of the combination data. Different part 207 is displayed in a color different from that of the same parts 205A, 205B.

In addition, in region 203 in which combination data is displayed, an image 209 showing characters “added” is displayed in such a manner as to be superimposed on the image of the combination data. Here, since image 209 showing characters “added” is displayed, it is shown that different part 207 is an added part which does not exist in the input data but exists in the related data. If different part 207 is a deleted part which does not exist in the related data but exists in the input data, an image showing characters “deleted” is displayed in such a manner as to be superimposed on the combination data, in place of image 209 showing characters “added.” Furthermore, if different part 207 includes both an added part and a deleted part, an image showing characters “changed” is displayed in a superimposed manner, in place of image 209 showing characters “added.”

Returning to FIG. 8, in step S42, it is determined whether or not a permission to output the input data is accepted. If the permission is accepted, the process proceeds to step S43, and if not, the process returns to the data output process. If an instruction is given to button 211 of combination data display window 201, the permission is accepted, and if an instruction is given to button 213, the permission is not accepted. This is because the process is ended without outputting the input data, if the permission is not accepted.

In step S43, the process branches based on the kind of data output process. If the image formation process is specified as a data output process on operation portion 115, the process proceeds to step S44. If the facsimile transmission process is specified as a data output process, the process proceeds to step S52. If the data storage process is specified as a data output process, the process proceeds to step S54. If the data transmission process is specified as a data output process, the process proceeds to step S56.

In step S44, it is determined whether or not combination data is selected in place of the input data. An inquiry window for inquiring whether to select combination data in place of the input data appears on display portion 114 to accept an instruction as to whether to select combination data. If the instruction to select combination data is accepted, the process proceeds to step S45, and if not, the process proceeds to step S50.

In step S45, it is determined whether or not the mode of image formation portion 30 is switched to the monochrome mode. If the mode of image formation portion 30 is the monochrome mode, the process proceeds to step S46, and if not, the process proceeds to step S49. In step S46, in order to form an image of combination data, a warning message appears to indicate that the mode of image formation portion 30 is to be switched to the color mode. Then, it is determined whether a permission is accepted or not (step S47). A button for inputting an instruction to permit switching appears, and it is determined whether an instruction is given to the button or not. If the permission is accepted, the process proceeds to step S48, and if not, the process returns to the data output process. The output process ends without forming an image of the combination data, if the process returns to the data output process.

In step S48, the mode of image formation portion 30 is switched to the color mode. Then, an image of combination data is formed. Specifically, combination data is output to image formation portion 30 so that image formation portion 30 is allowed to form an image of the combination data.

In step S50, attribute information is attached to the input data. An image representing the attribute information by characters or an image representing the attribute information by a code such as a barcode is combined with the image of the input data. Alternatively, the attribute information may be embedded in a pattern and the image of the pattern may be combined with the image of the input data, or the attribute information may be embedded in the input data using a watermarking technique.

In step S51, an image of the input data having the attribute information attached thereto is formed, and the process returns to the data output process. Specifically, the input data is output to image formation portion 30 so that image formation portion 30 is allowed to form an image of the input data. Since the attribute information is attached to the input data, the image formed on paper includes the attribute information. Therefore, when the image formed on paper is subsequently read by image reading portion 20 (step S03 in FIG. 6), the attribute information is extracted from the read original document image in step S05 in FIG. 6.

In step S52, similar to step S50, attribute information is added to the input data. Then, the input data having the attribute information attached thereto is faxed (step S53), and the process then returns to the data output process. Specifically, the input data is output to facsimile portion 122 so that facsimile portion 122 is allowed to transmit the input data to a recipient included in the instruction for the facsimile transmission process.

In step S54, attribute information is set in the profile. Then, the input data and the profile are stored in a location of HDD 116 as included in the instruction for the data storage process (step S55), and the process then returns to the data output process.

In step S56, the input data and the attribute information are transmitted, and the process then returns to the data output process. Specifically, the input data and the attribute information are output to data communication control portion 117 so that communication control portion 117 is allowed to transmit the input data and the attribute information to a recipient included in the instruction for the data transmission process.

FIG. 10 is a flowchart showing an exemplary flow of the normal output process. The normal output process is a process performed in step S17 in FIG. 6. Referring to FIG. 10, the same process as in FIG. 8 is denoted with the same reference character. FIG. 10 differs from the output process in FIG. 8 in that step S41, step S42 and steps S44-S49 in FIG. 8 are deleted. All the other processes are the same and therefore the description will not be repeated here.

As described above, when receiving as input data either an original document image obtained by image reading portion 20 reading an original document or data stored in HDD 116, MFP 100 in the first embodiment extracts from the data stored in HDD 116 as the related data the data with a file name identical or similar to the file name of the input data and with the most recent date and time of storage into HDD 116, which is later than the recording date and time included in the attribute information of the input data. Then, combination data formed by combining the difference between the input data and the related data with the input data is displayed on display portion 114. Therefore, when MFP 100 is operated to perform a process, the input data to be processed by the process determined by this operation is determined. Furthermore, if the input data is not the latest version, combination data is displayed. Since the difference between the input data and the related data is displayed in the combination data, the user can recognize that the data to be processed is not the latest version. In addition, since the difference is displayed, whether to continue the process even with not latest version can be determined. Therefore, without any special operation, it is possible to attract the user's attention to process data of the latest version.

### Second Embodiment

MFP 100 in the first embodiment compares the input data with one related data related thereto. However, when one data is designated, MFP 100 in a second embodiment compares that data with a plurality of data related thereto. A different point from MFP 100 in the first embodiment will be described below.

In the following description, MFP 100 in the second embodiment sets an email as a target to be processed. However, data to be processed is not limited to an email as long as one data is used as a basis and the related data includes a part which is a new part added to the base data.

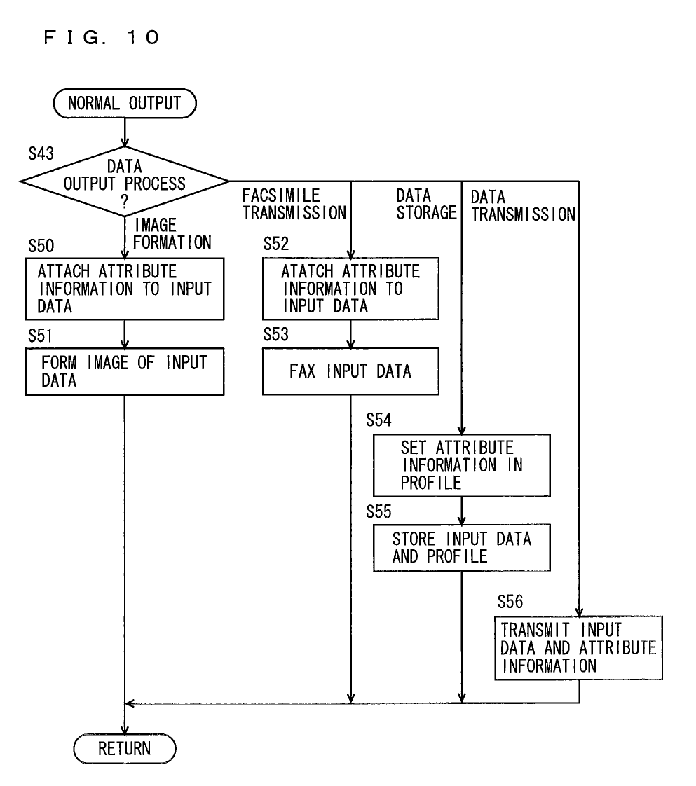

FIG. 11 is a functional block diagram showing an overall function of CPU included in MFP in the second embodiment. Referring to FIG. 11, CPU 111 includes an email reception portion 81 for receiving an email, a related mail obtaining portion 83 for obtaining a related mail related to the received email, a mail difference extraction portion 85 extracting the difference between the received email and the related mail, a mail combination portion 87 generating combination data based on the received email and the difference, and a mail output portion 89 outputting combination data.

Email reception portion 81 receives an email from PC 200. Email reception portion 81 outputs the received email as a target mail to related mail obtaining portion 83, mail difference extraction portion 85 and mail combination portion 87. Furthermore, email reception portion 81 outputs apparatus identification information for identifying PC 200, which has transmitted the email, to mail output portion 89.

Related mail obtaining portion 83 obtains from mail server 300 a related mail related to the target mail input from email reception portion 81. Specifically, a related mail transmission request is transmitted to mail server 300. The related mail transmission request includes the target mail.

Mail server 300 stores transmitted/received emails and extracts from the stored emails as the related mails all the emails in which the same email address as the sender or the recipient of the target mail is set in the sender or the recipient and of which subjects partially agree with the subject of the target mail. An example of the email having a subject that partially agrees is as follows. A subject of a reply mail includes “Re:” added to the subject of a sent email, and the email of which subject agrees excluding “Re:” is extracted. Then, mail server 300 sends the extracted related mail by return to MFP 100 which has transmitted the related mail transmission request. Related mail obtaining portion 83 outputs the related mail received from mail server 300 to mail difference extraction portion 85. If a plurality of related mails are received from mail server 300, all the received related mails are output to mail difference extraction portion 85.

Mail difference extraction portion 85 extracts the difference excluding the overlapped part between the target mail input from email reception portion 81 and the related mail. Then, the extracted difference is output to mail combination portion 87.

Mail combination portion 87 combines the target mail input from email reception portion 81 with the difference input from mail difference extraction portion 85 to generate combination data. Mail combination portion 87 outputs the generated combination data to mail output portion 89.

Mail output portion 89 transmits the combination data input from mail combination portion 87 to PC 200 specified by the apparatus identification information input from email reception portion 81. In addition, when a combination data print instruction is received from PC 200, mail output portion 89 allows image formation portion 30 to form an image of the combination data according to the received print instruction.

FIG. 12 is a flowchart showing an exemplary flow of a client process performed by CPU included in PC. Referring to FIG. 12, CPU of PC 200 performs user authentication (step S101). The user identification information input by an operator of PC 200 at a time of log-in is accepted in order to authenticate who is the user of PC 200. As a result of the user authentication, the user identification information assigned to the operator is obtained. The operator who is authenticated as a user is referred to as a log-in user hereinafter.

Then, an email is transmitted to MFP 100 (step S102). An email transmission/reception program is installed in PC 200, and the emails transmitted/received by the log-in user are stored in HDD of PC 200. The email transmitted in step S102 is one of the emails that have been transmitted/received so far by the log-in user. When the log-in user designates one of a plurality of emails stored in HDD or the like of PC 200 and inputs an instruction to transmit it to MFP 100, the designated email and the user identification information of the log-in user are transmitted to MFP 100.

In the process in the case where MFP 100 receives an email, which will be described in detail later, MFP 100 generates combination data formed by adding a part related to the received email and sends by reply to PC 200. Therefore, in PC 200, the combination data transmitted from MFP 100 is received (step S103).

Then, PC 200 displays the combination data on the display (step S104). Thus, the log-in user can visually recognize the combination data and therefore determine whether to print the combination data. In step S105, it is determined whether or not a print instruction is accepted. If a print instruction is accepted, the process proceeds to step S106, and if not, step S106 is skipped and the process then ends. In step S106, the print instruction is transmitted to MFP 100, and the process then ends.

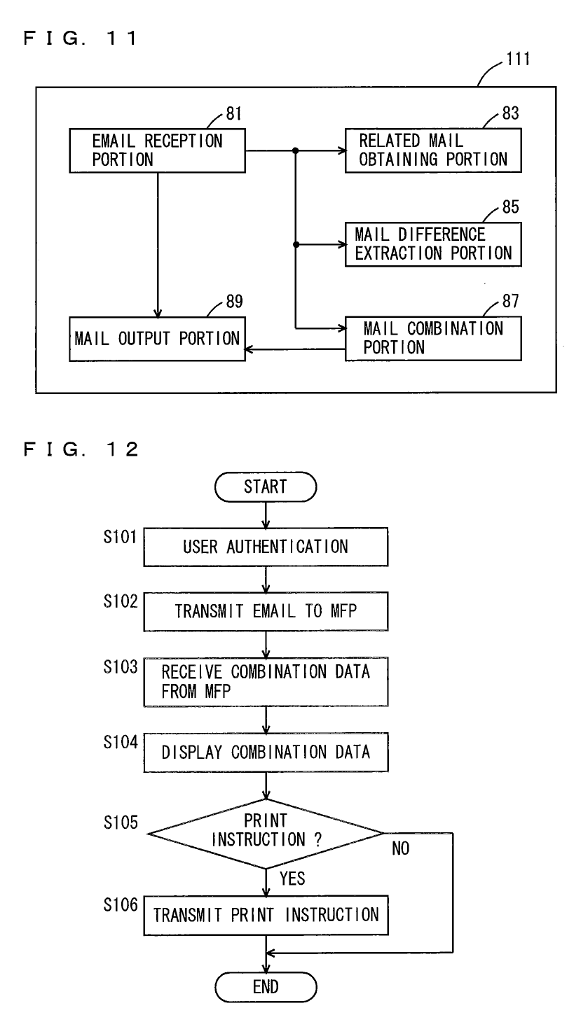

FIG. 13 is a flowchart showing an exemplary flow of a data output process performed in MFP in the second embodiment. The data output process is a process performed by CPU 111 by CPU 111 executing a data output program. Referring to FIG. 13, CPU 111 stands by until an email is received (NO in step S111), and upon reception of an email, the email is set as a target mail. The process then proceeds to step S112. Here, an email is received from PC 200, by way of example. In step S111, apparatus identification information for identifying PC 200 is received together with the email. The apparatus identification information is, for example, location information on the network of PC 200, and here, IP (Internet Protocol) address or MAC (Media Access Control) address is used. The apparatus identification information may be any information as long as it specifies PC 200, and therefore, for example, a session ID may be used which is allocated to the session when a session with PC 200 is established.

In step S112, a related mail transmission request is transmitted to mail server 300. The related mail transmission request includes the target mail. Now, a related mail transmission process performed in mail server 300 receiving the related mail transmission request will be described.

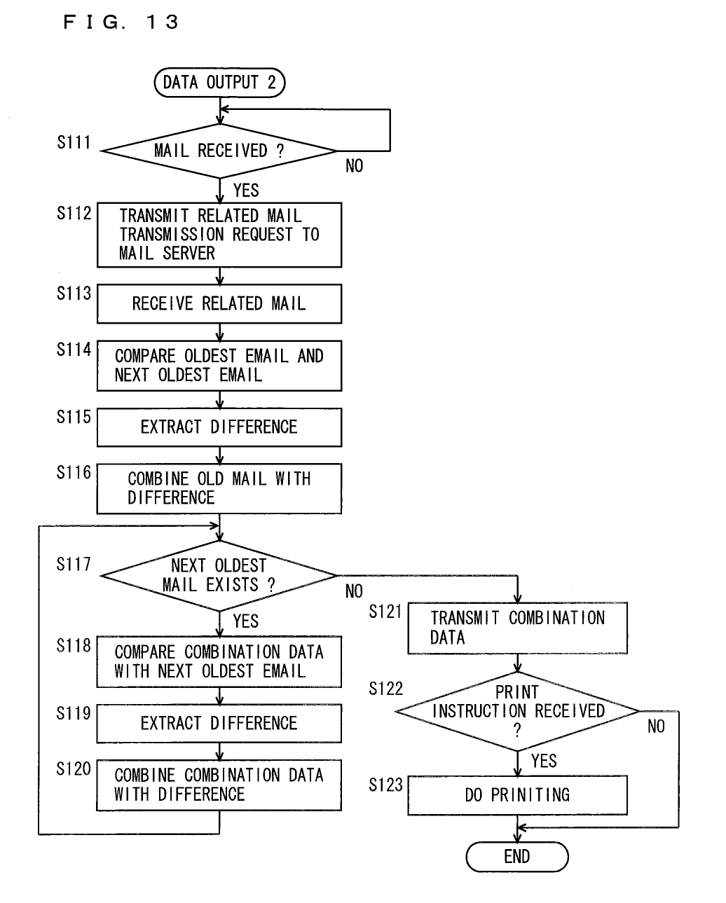

FIG. 14 is a flowchart showing an exemplary flow of the related mail transmission process, The related mail transmission process is a process performed by CPU included in mail server 300 by CPU of mail server 300 executing a related mail transmission program. Referring to FIG. 14, CPU included in mail server 300 stands by until a related mail transmission request is received from MFP 100 (NO in step S131), and upon reception of a related mail transmission request, the process proceeds to step S132.

In step S132, a related mail is extracted. Specifically, extracted from the emails stored by mail server 300 as related mails are all of the emails in which the same mail address as the sender or the recipient of the target mail included in the related mail transmission request is set as a sender or a recipient and of which subjects partially agree with the subject of the target mail.

Then, the extracted related emails are transmitted to MFP 100 which has transmitted the related mail transmission request (step S133), and the process then ends.

Returning to FIG. 13, CPU 111 receives the related mails from mail server 300 (step S113). Then, the oldest email and the next oldest email among the target mail and the related mails are compared with each other (step S114). Then, the difference between the oldest email and the next oldest email is extracted (step S115). A part different between them is extracted as the difference. Then, the older email and the difference are combined together, thereby generating combination data (step S116).

In the next step S117, it is determined whether or not there exists the next oldest email among the target mail and the related mails. If there exists the next oldest email, the process proceeds to step S118, and if not exist, the process proceeds to step S121. In step S118, the combination data is compared with the next oldest email. Then, the difference between the combination data and the next oldest email is extracted (step S119). A part different between them is extracted as the difference. Then, the combination data and the difference are combined together as new combination data (step S120). Then, the process returns to step S117.

In step S121, the combination data is transmitted to PC 200 which has transmitted the target mail. Specifically, the combination data and the apparatus identification information received in step S111 are output to data communication control portion 117, so that communication control portion 117 is allowed to transmit the combination data to PC 200.

Then, it is determined whether or not a print instruction is received from PC 200 (step S122). If a print instruction is received (YES in step S122), an image of the combination data is formed (step S123). The process then ends. Specifically, the combination data is output to image formation portion 30 so that image formation portion 30 is allowed to form an image of the combination data. On the other hand, if a print instruction is not received (NO in step S122), the process ends.

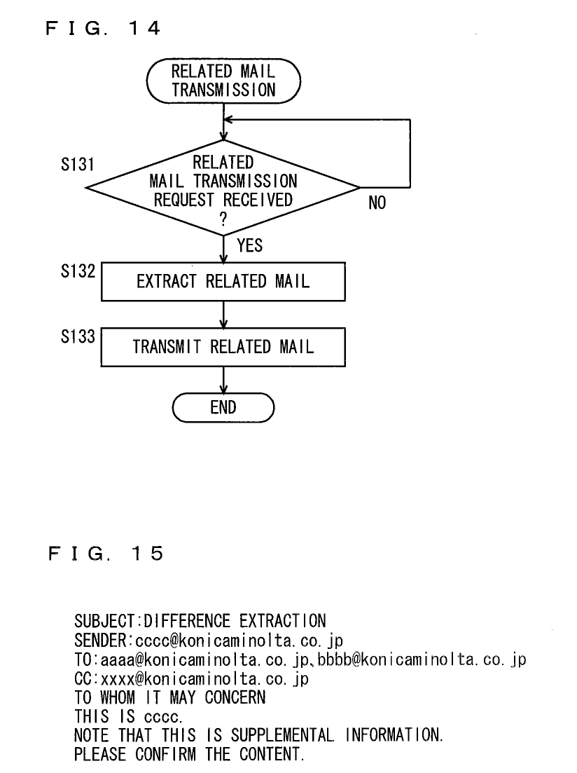

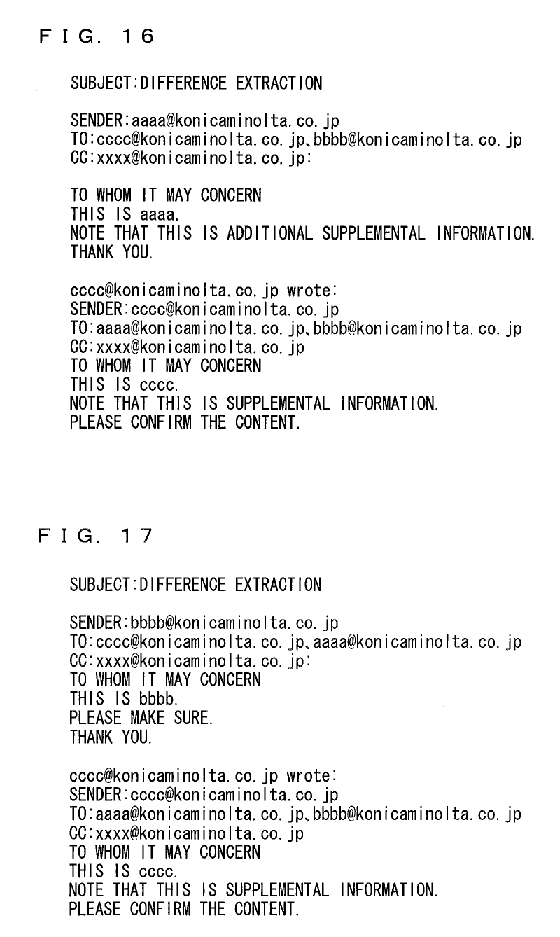

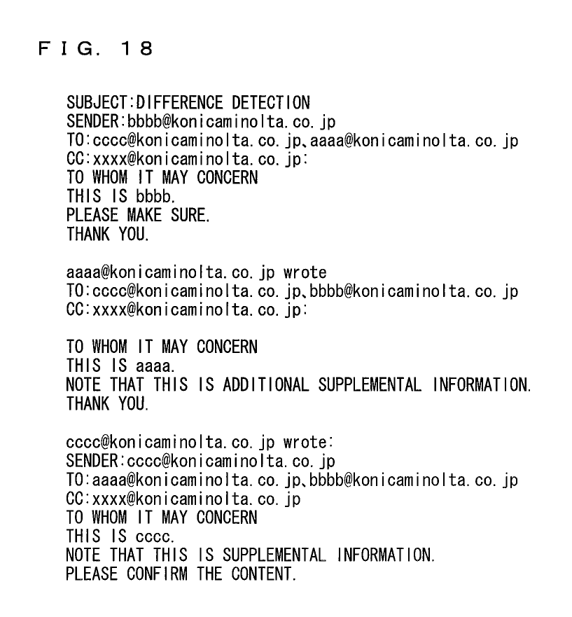

FIG. 15-FIG. 17 are diagrams showing an example of emails. The emails shown in FIG. 15-FIG. 17 are emails related to each other, all having the same subject. The email shown in FIG. 16 is a reply to the email shown in FIG. 15. The email shown in FIG. 17 is also a reply to the email shown in FIG. 15.

Assuming that the emails shown in FIG. 15-FIG. 17 are stored in mail server 300, when MFP 100 receives the email shown in FIG. 16 from PC 200, the emails shown in FIG. 15 and FIG. 17 are extracted as related mails from mail server 300 and sent by reply to MFP 100.

In MFP 100, combination data is generated based on the emails shown in FIG. 15-FIG. 17. FIG. 18 is a diagram showing an example of combination data. Referring to FIG. 18, the combination data includes differences which are different between three emails shown in FIG. 15-FIG. 17 and a part identical in all of them.

In MFP 100 in the second embodiment, obtained as related mails are emails in which the same email address as the email address set in the sender or the recipient of the target email is set in the sender or the recipient and of which subjects partially agree with the subject of the target email. Then, combination data is generated by combining differences which are different between the target mail and the related mails and the part identical in all of them together. Therefore, all of the related mails among a plurality of emails can be aggregated in one data. As a result, a plurality of emails can be viewed in a single operation, thereby facilitating the operation of viewing emails.

It is noted that although in the second embodiment, emails are stored in mail server 300, they may be stored in MFP 100 or may be stored in PC 200. In this case, the process of extracting the related mails in the related mail transmission process shown in FIG. 14 is performed by CPU 111 of MFP 100 or CPU of PC 200 which store emails. Furthermore, if emails are stored in PC 200, the data output process shown in FIG. 13 is performed by CPU of PC 200.

It is noted that although in the foregoing embodiments, MFP 100 has been described as an example of the data processing apparatus, it is needless to say that the present invention can be understood as a data processing method for performing the processes shown in FIG. 6-FIG. 8 and FIG. 12-FIG. 14 and a data processing program for causing a computer to execute the data processing method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data processing apparatus comprising:
a storage portion to store data;
a data acceptance portion to accept target data to be output;
a related data extraction portion to extract related data that is related to said target data and is newer than said target data from data stored in said storage portion;
a difference extraction portion to extract a difference between extracted said related data and said target data; and
a difference output portion to output said difference.

2. The data processing apparatus according to claim 1, further comprising:
an output portion to output said target data; and
a temporary stop portion to temporarily stop said target data from being output by said output portion, if a difference is extracted by said difference extraction portion.

3. The data processing apparatus according to claim 1, further comprising:
a combination portion to combine an image of said difference with an image of said target data in a color different from a color of the image of said target data to generate combination data;
an image formation portion to form an image;
a mode switch portion to switch a mode of said image formation portion between a monochrome mode of forming an image in a single color and a color mode of forming an image in multiple colors; and
a stop portion to stop formation of an image of said combination data by said image formation portion, if the mode of said image formation portion is switched to the monochrome mode by said mode switch portion.

4. The data processing apparatus according to claim 3, wherein said difference output portion displays said combination data.

5. The data processing apparatus according to claim 1, further comprising a reading portion to read an original document image formed on a recording medium, wherein
said data acceptance portion accepts said original document image read by said reading portion as said target data.

6. The data processing apparatus according to claim 1, further comprising:
a reading portion to read an original document image formed on a recording medium;
an original document image storage portion to store said original document image read by said reading portion into said storage portion;
a location information transmission portion to externally transmit location information as to where said original document image is stored in said storage portion; and
an original document image reading portion to read said original document image specified by input said location information in response to said location information being externally input, wherein
said data acceptance portion accepts said original document image read by said original document reading portion as said target data.

7. The data processing apparatus according to claim 1, further comprising:
a data designation acceptance portion to accept designation of any one of the data stored in said storage portion; and
a reading portion to read data specified by said accepted designation from said storage portion, wherein
said data acceptance portion accepts data read by said reading portion as said target data.

8. The data processing apparatus according to claim 1, wherein
said storage portion stores data with addition of identification information for identifying the data and a date and time of storage, and
said related data extraction portion extracts, from the data stored in said storage portion, data with identification information identical or similar to the identification information of said target data and with the most recent date and time of storage into said storage portion.

9. The data processing apparatus according to claim 8, further comprising a reading portion to read an original document image formed on a recording medium, wherein
said data acceptance portion accepts said original document image read by said reading portion as said target data, and
said related data extraction portion includes an attribute information extraction portion to extract, from said original document image read by said reading portion, attribute information including said identification information and a date and time at which data serving as a basis on which said original document image was formed was stored.

10. The data processing apparatus according to claim 1, wherein
said storage portion stores data with addition of identification information for identifying the data and a date and time of storage, and
said related data extraction portion extracts, as said related data, data that has identification information identical or similar to the identification information of said target data and that is similar to said target data and has a most recent date and time of storage into said storage portion.

11. The data processing apparatus according to claim 1, wherein
said storage portion stores data with addition of a date and time at which the data was stored, and
said related data extraction portion extracts, as said related data, data that is similar to said target data and that has a most recent date and time of storage into said storage portion.

12. The data processing apparatus according to claim 1, wherein
said difference extraction portion extracts a difference which is different between extracted said related data and said target data,
said data processing apparatus further comprising a combination portion to generate one combination data with any one of said related data and said target data, excluding a portion overlapping between said target data and said related data, based on extracted said difference, wherein
said difference output portion outputs generated said combination data.

13. The data processing apparatus according to claim 12, further comprising an email reception portion to receive an email, wherein
said data acceptance portion accepts received said email as said target data.

14. A data processing method performed in a data processing apparatus including a storage portion to store data, comprising the steps of:
accepting target data to be output;
extracting data that is related to said target data and is newer than said target data from data stored in said storage portion;
extracting a difference between extracted said related data and said target data; and
outputting said difference.

15. A data processing program embodied on a computer readable medium for causing a computer including a storage portion to store data to execute processing including the steps of:
accepting target data to be output;
extracting data that is related to said target data and is newer than said target data from data stored in said storage portion;
extracting a difference between extracted said related data and said target data; and
outputting said difference.
